(19) United States
(12) Patent Application Publication
(10) Pub. No.: US 2025/0178720 A1
(43) Pub. Date: Jun. 5, 2025

(54) TAXIING DEVICE WITH COMBINED RADIAL AND AXIAL MAGNETIC FLUX BRAKING, AND AIRCRAFT EQUIPPED WITH SAME

(71) Applicant: SAFRAN LANDING SYSTEMS, Velizy Villacoublay (FR)

(72) Inventors: Graeme KLIM, MOISSY-CRAMAYEL (FR); Duy-Minh NGUYEN, MOISSY-CRAMAYEL (FR)

(73) Assignee: SAFRAN LANDING SYSTEMS, Velizy Villacoublay (FR)

(21) Appl. No.: 18/842,945

(22) PCT Filed: Feb. 28, 2023
(86) PCT No.: PCT/EP2023/055045

§ 371 Date: Aug. 30, 2024

(30) Foreign Application Priority Data
Mar. 2, 2022 (FR) 2201832

(51) Int. Cl. B64C 25/42; H02K 49/04

(52) U.S. Cl. CPC B64C 25/42; H02K 49/043

(57) ABSTRACT

A rolling device for a vehicle includes a wheel having a hub to be mounted to pivot on a shaft and a rim including first annular portion delimiting a recess receiving an eddy current magnetic braking device including a stator constrained to rotate with the shaft, a rotor constrained to rotate with the wheel and provided with a first surface facing a first surface of the stator to form a first pair of surfaces, and first magnets for generating a first magnetic flux which passes through the first pair of surfaces. The rotor includes a second surface facing a second surface of the stator to form a second pair of surfaces and the magnetic braking device includes second magnets for generating a second magnetic flux which passes through the second pair of surfaces. The first magnetic flux is axial and the second magnetic flux is radial.

The present invention relates to the field of braking for vehicle wheels such as aircraft wheels.

### BACKGROUND OF THE INVENTION

An aircraft wheel generally comprises a rim linked by a disc to a hub mounted so as to rotate on a shaft (axle or spindle) secured to one end of a landing gear.

Friction braking devices are known comprising a stack of brake discs that is housed in a space extending between the rim and the hub and that comprises an alternation of rotor discs constrained to rotate with the wheel and stator discs that are fixed in relation to the wheel support shaft. The braking device also comprises hydraulic or electromechanical actuators mounted on an actuator carrier and arranged to apply a controlled braking force to the stack of discs in such a way as to brake the rotation of the wheel.

Equipping such braked wheels with an electromagnetic auxiliary brake that dissipates energy by means other than mechanical friction has been proposed, in particular in document FR-A-2953196. However, the free space at the wheel is extremely limited, complicating the operation of installing an auxiliary brake.

Also known are magnetic braking devices referred to as eddy current magnetic braking devices, or eddy current brakes, which are used for the brakes of vehicles wheels and, more particularly, aircraft wheels. Document WO-A-2014/029962 describes such a device comprising a stator that is provided with one or more magnets and is mounted facing an electrically conductive rotor.

Magnetic braking devices are known, for example, from documents US-A-2008/179146, CN-A-104065236, FR-A-2996378, US-A-2008/258014, FR-A-3103329, US-A-2019/036402 and CN-A-113374809. Document US-A-20200300310 also describes an eddy current magnetic braking device.

The performances of an eddy current magnetic braking device generally depends on the power and dimensions of the magnets used. The braking device is therefore relatively heavy and bulky when high maximum braking power is required. That is the case, for example, for use on an aeroplane, where weight and space requirement are severe constraints.

### OBJECT OF THE INVENTION

The aim of the invention is, in particular, to pro-pose a rolling device that offers improved braking performance while maintaining a reasonable space requirement.

### SUMMARY OF THE INVENTION

To this end, according to the invention, a rolling device for a vehicle is provided, comprising a wheel having a hub arranged to be mounted in order to pivot on a shaft and a rim linked to the hub by a disc so as to extend coaxially with the hub. The rim comprises at least one first annular portion protruding axially from the disc and delimiting therewith a recess receiving an eddy current magnetic braking device comprising a stator constrained to rotate with the shaft, a rotor constrained to rotate with the wheel. The rotor is provided at least with a first surface facing a first surface of the stator to form a first pair of surfaces, and a second surface facing a second surface of the stator to form a second pair of surfaces. The magnetic braking device comprises at least a first plurality of magnets for generating a first magnetic flux which passes through the first pair of surfaces and a second plurality of magnets for generating a second magnetic flux which passes through the second pair of surfaces. The first pair of surfaces and the first plurality of magnets are arranged in such a way that the first magnetic flux is axial and the second pair of surfaces and the second plurality of magnets are arranged in such a way that the second magnetic flux is radial.

This arrangement makes it possible to combine radial flux eddy current magnetic braking and axial flux eddy current magnetic braking. This enhances the eddy current magnetic braking without changing the space requirement of the braking device, meaning that it does not adversely affect the integration of the rolling device into a vehicle.

Advantageously, the first pair of surfaces is arranged in the vicinity of a rim flank secured to the first annular portion of the rim opposite the disc and the second pair of surfaces is arranged in the recess in the vicinity of the first annular portion of the rim.

As the braking torque is greater the further away the resistive force is applied from the axis of rotation of the wheel, positioning the pairs of surfaces in this way makes it possible to generate a relatively high braking torque.

Preferably, the rotor has at least one third surface facing a third surface of the stator to form a third pair of surfaces and the magnetic braking device comprises at least a third plurality of magnets for generating a third magnetic flux, which is radial, passing through the third pair of surfaces.

This improves braking efficiency.

Also preferably,

According to one particular embodiment, the rotor comprises a first rotor sleeve that extends in the recess along the annular portion of the rim and that has a surface forming the first surface of the rotor, and a rotor flange protruding outwards from the end of the rotor sleeve in such a way as to extend in front of a flank secured to the annular portion of the rim and having, opposite the flank of the rim, a surface forming the second surface of the rotor; and the stator comprises a stator outer sleeve arranged to be engaged in the first rotor sleeve and have a surface forming the first surface of the stator facing the first surface of the first rotor sleeve to form the first pair of surfaces, and a stator flange protruding outwards from the stator outer sleeve in such a way as to have a surface forming the second surface of the stator extending facing the second surface of the rotor to form the second pair of surfaces.

The invention also relates to an aircraft equipped with at least one such rolling device.

Other features and advantages of the invention will become apparent on reading the following description of particular and non-limiting embodiments of the invention.

### BRIEF DESCRIPTION OF THE DRAWINGS

Reference is made to the accompanying drawings, in which:

FIG. 1 is a partial schematic view of an aircraft equipped with rolling devices according to the invention;

FIG. 2 is a partial schematic view of a rolling device according to a first embodiment of the invention, in axial half section, with the stator of the magnetic brake in the braking position;

FIG. 3 is a partial perspective view of this rolling device with the stator of the magnetic brake in the braking position;

FIG. 4 is a view similar to that of FIG. 2 of this rolling device with the stator of the magnetic brake in the intermediate position;

FIG. 5 is a view similar to that of FIG. 3 of this rolling device with the stator of the magnetic brake in the intermediate position;

FIG. 6 is a view similar to that of FIG. 2 of this rolling device with the stator of the magnetic brake in a freely rotating position;

FIG. 7 is a view similar to that of FIG. 3 of this rolling device with the stator of the magnetic brake in a freely rotating position;

FIG. 8 is a schematic view, along the axis of rotation of the wheel, of the arrangement of the magnets on the stator;

FIG. 9 is a view similar to that of FIG. 2 of a rolling device according to one variant of the first embodiment;

FIG. 10 is a partial schematic view of a rolling device according to a second embodiment of the invention, in axial half section, with the stator of the magnetic brake in the braking position;

FIG. 11 is a partial schematic view of a rolling device according to a third embodiment of the invention, in axial section, with the stator of the magnetic brake in the braking position; and

FIG. 12 is a partial schematic view of a rolling device according to a fourth embodiment of the invention, in axial section, with the stator of the magnetic brake in the braking position.

### DETAILED DESCRIPTION OF THE INVENTION

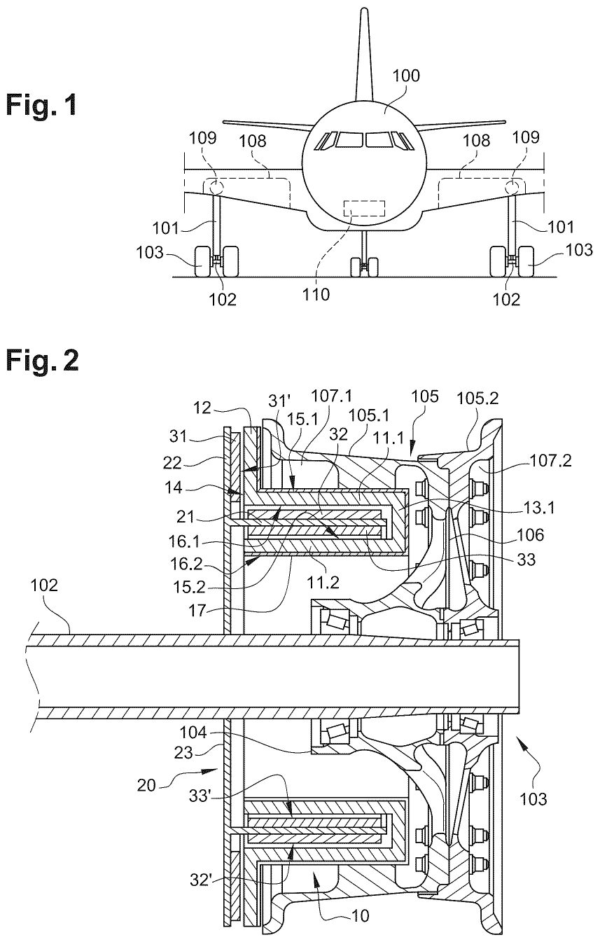

In reference to FIGS. 1 to 8, the first embodiment of the invention is described in application to an aircraft 100 comprising rolling devices each forming a landing gear mounted on the structure of the aircraft to pivot between a deployed position (shown in FIG. 1) and a position stowed in a hold 108 under the action of a landing gear actuator 109 that is known per se and connected to an electronic control unit 110. Each landing gear comprises a leg 101 having one end provided with two coaxial shafts 102, on each of which a wheel 103 is mounted so as to pivot. In a manner that is known per se, each wheel 103 comprises a hub 104 mounted to pivot on the shaft 102 and a rim 105 that is linked to the hub 104 by a disc 106 and that has two annular flanks between which a tyre is accommodated. The two shafts 102 are made from a single piece, hollow and have an external surface supporting the bearings guiding the hub 104 of each wheel 103 in rotation about the central axis of the shaft 102.

The rim 105 comprises a first annular portion 105.1 that protrudes from the disc 106 and facing the hub 104, delimiting therewith a first annular recess 107.1 having one end closed by the disc 106 and one end that opens towards the leg 101. The rim 105 comprises a second annular portion 105.2 protruding from the disc 106 opposite the first annular portion 105.1, delimiting a second cylindrical recess 107.2 having one end closed by the disc 106 and an opposite open end.

According to the invention, the wheels 103 are each equipped with a magnetic braking device accommodated in the first recess 107.1.

The magnetic braking device comprises a rotor generally designated 10 and a stator generally designated 20.

The rotor 10 comprises a first sleeve 11.1 that is engaged in the first annular portion 105.1 of the rim 105 and that has an external surface 15.1 extending in the vicinity of the first annular portion 105.1 and an internal surface 16.1 on the opposite side to the external surface 15.1. The first sleeve 11.1 comprises a first end adjacent to the disc 106 and, at the opposite end, a second end that protrudes from the first recess 107.1 and that is provided with a flange 12 that protrudes radially outwards from the second end to extend in front of the flank secured to the annular portion 105.1 of the rim 105 and parallel to said flank.

The rotor 10 comprises a second sleeve 11.2 extending inside the first sleeve 11.1 to form a channel having a bottom partition 13.1 extending radially to join the first end of the first sleeve 11.1 with a first end of the second sleeve 11.2. The second sleeve 11.2 has an external surface 15.2 extending facing the internal surface 16.1 of the first sleeve 11.1 and, on the opposite side, an internal surface 16.2.

The rotor 10 is made from copper (or any other electrically conductive material, such as aluminium) and is provided on the same side as the rim 105, the disc 106 and the hub 104 with a heat shield 17 for limiting the trans-mission of heat towards the other components of the wheel, including the rim 105 and the tyre. The rotor 10 is constrained to rotate with the annular portion 105.1, for example by means of screws fastening the flange 12 to the flank of the annular portion 105.1.

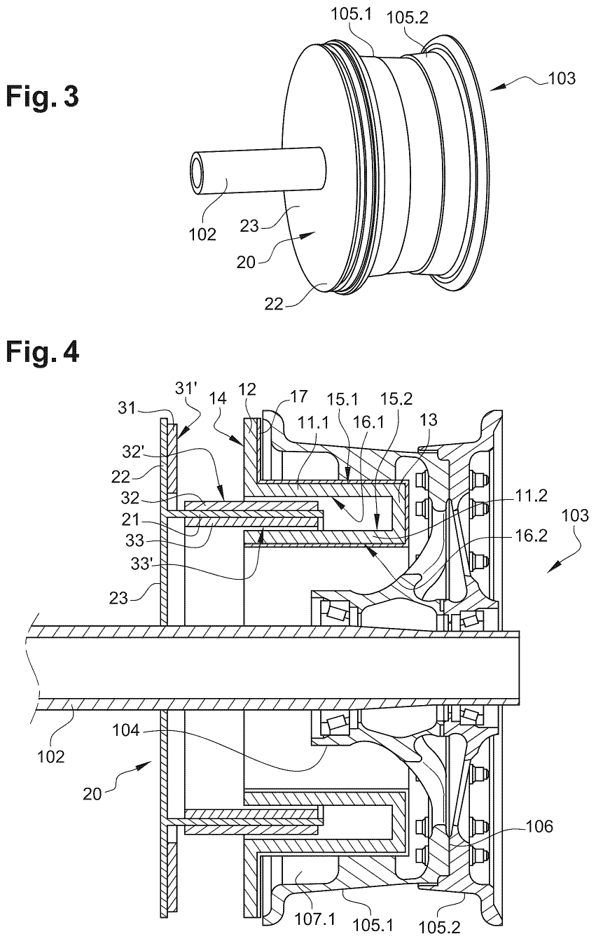

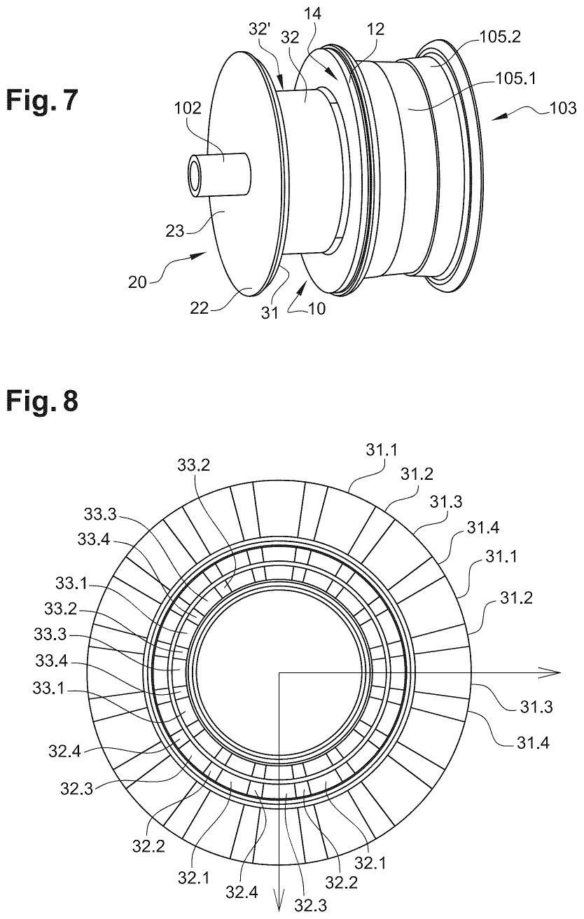

The stator 20 comprises a single sleeve, referred to as the outer sleeve, 21 which is arranged to be able to be engaged between the sleeves 11.1, 11.2 and which has a first end at the same end as the bottom partition 13 and, at the opposite end, a second end from which a flange 22 protrudes outwards, extending facing the flange 12 and parallel thereto. The flange 22 and the sleeve 21 are secured to a disc component 23 constrained to rotate with the shaft 102, for example by a rib/groove system, and mechanically linked to a linear electromechanical actuator that is not shown in the figures but is known per se. The linear electromechanical actuator is arranged to move the stator 20 between:
a braking position in which the flanges 12, 22 are brought closer together and the sleeve 21 is engaged between the sleeves 11.1, 11.2 (FIGS. 2 and 3); and
a freely rotating position in which the flanges 12, 22 are spaced apart and the sleeve 21 is disengaged from the sleeves 11.1, 11.2 (FIGS. 6 and 7).

The magnetic braking device further comprises three magnetic rings 31, 32, 33 each comprising a plurality of magnets.

The magnetic ring 31 is fastened to the flat annular surface of the ring 22 extending facing the flat annular surface 14 of the ring 12 opposite the flank of the annular portion 105.1. The free main surface 31′ of the magnetic ring 31 forms a first surface of the stator 20 through which an axial magnetic flux is emitted towards a first surface of the rotor 10 formed by the flat annular surface 14 of the ring 12. The free main surface 31′ and the flat annular surface 14 form a first pair of magnetic flux passage surfaces (a first air gap) when the stator 20 is in the braking position.

The magnetic ring 32 is fastened to the external cylindrical surface of the outer sleeve 21 extending facing the internal surface 16.1 of the first sleeve 11.1. The free main surface 32′ of the magnetic ring 32 forms a second surface of the stator 20 through which a radial magnetic flux is emitted towards a second surface of the rotor 10 formed by the internal surface 16.1 of the first sleeve 11.1. The free main surface 32′ and the internal surface 16.1 form a second pair of magnetic flux passage surfaces (a second air gap) when the stator 20 is in the braking position.

The magnetic ring 33 is fastened to the internal cylindrical surface of the outer sleeve 21 extending facing the external surface 15.2 of the second sleeve 11.2. The free main surface 33′ of the magnetic ring 33 forms a third surface of the stator 20 through which a radial magnetic flux is emitted towards a third surface of the rotor 10 formed by the external surface 15.2 of the second sleeve 11.2. The free main surface 33′ and the internal surface 15.2 form a third pair of magnetic flux passage surfaces (a third air gap) when the stator 20 is in the braking position.

In reference to FIG. 8, the first magnetic ring 31 comprises first magnets 31.1, 31.3 that have a first magnetization vector substantially perpendicular to the annular main face of the flange 22 and that are separated in pairs by a second magnet 31.2, 31.4 having a second magnetization vector substantially perpendicular to the first magnetization vectors of the two first magnets 31.1, 31.3 between which the second magnet 31.2, 31.4 is located. It should be noted that the magnetization vector indicates the direction of the magnetic field generated by a magnet and extends, in the magnet, from the south pole to the north pole. More precisely, the magnets 31.1, 31.2, 31.3, 31.4 are in the shape of angular sectors and have a length measured in a radial direction of the stator 20 and an average width measured in a locally tangential direction of the flange 22 (i.e., perpendicular to the direction of the length) halfway along said length. The lengths and widths are measured in directions locally parallel to the main surface of the flange 22.

The magnets 31.1, 31.2, 31.3, 31.4 are arranged in a Halbach array, alternating in the circumferential direction of the ring of magnets 31 (and therefore of the stator 20) as follows: a magnet 31.1, a magnet 31.2, a magnet 31.3, a magnet 31.4, a magnet 31.1, a magnet 31.2, a magnet 31.3, a magnet 31.4 and so on. In this case:
each magnet 31.1 has its magnetization vector emanating from the first main face 31′ towards the flange 12 (its north pole emerges on said main face);
each magnet 31.2 has its magnetization vector extending from the adjacent magnet 31.1 towards the adjacent magnet 31.3;
each magnet 31.3 has its magnetization vector entering said main face 31′ (its south pole emerges on said main face); and
each magnet 31.4 has its magnetization vector extending from the adjacent magnet 31.1 towards the adjacent magnet 31.3.

It should be understood that the magnets 31.2, 31.4 arranged to each side of a given magnet 31.1 have their magnetization vector oriented in opposing directions.

Preferably, according to one advantageous version of the invention, the magnets 31.1, 31.2, 31.3, 31.4 have widths such that the first magnets 31.1, 31.3 are spaced apart in pairs by a first distance (equal to the width of the magnets 31.2, 31.4) less than a second distance (equal to the width of the magnets 31.1, 31.3) separating the second magnets 31.2, 31.4 in pairs. The best results are obtained when the width of the second magnets 31.2, 31.4 is approximately 70% that of the first magnets 31.1, 31.3.

The magnets 31.1, 31.2, 31.3, 31.4 are identical in length. It should be understood that the magnets 31.2, 31.4 occupy less of the surface area of the main face 31′ than the magnets 31.1, 31.3.

The Halbach array arrangement of the magnets 31.1, 31.2, 31.3, 31.4 helps optimize and concentrate the magnetic flux produced by the magnets 31.1, 31.3 by reducing the return path of the magnetic flux that passes through the magnets 31.2, 31.4 and not through the flange 22, the weight of which may be reduced because it does not need to perform a magnetic flux conduction function.

The second magnetic ring 32 has magnets in the form of annular sectors positioned adjacent to one another by their parallel edges around the sleeve 21 with the same alternation as those of the first magnetic ring 31 to form a Halbach array around the circumference of the sleeve 21. Therefore, there are first magnets 32.1, 32.3 that each have a first magnetization vector extending along a local radius (direction locally normal to the external surface of the outer sleeve 21 facing the magnet 32.1, 32.3 in question) and that are separated in pairs by a second magnet 32.2, 32.4 having a second magnetization vector substantially tangential to the external surface of the sleeve 21 and contained in a plane perpendicular to the central axis of the sleeve 21.

The magnets 32.1, 32.2, 32.3, 32.4 are arranged in a Halbach array, alternating in the circumferential direction of the sleeve 21 as follows: a magnet 32.1, a magnet 32.2, a magnet 32.3, a magnet 32.4, a magnet 32.1, a magnet 32.2, a magnet 32.3, a magnet 32.4 and so on. In this case:
each magnet 32.1 has its magnetization vector emanating from the main surface 32′ (its north pole emerges on the main surface 32′);
each magnet 32.2 has its magnetization vector extending from the adjacent magnet 32.1 towards the adjacent magnet 32.3;
each magnet 32.3 has its magnetization vector entering the main surface 32′ (its south pole emerges on the main surface 32′); and
each magnet 32.4 has its magnetization vector extending from the adjacent magnet 32.1 towards the adjacent magnet 32.3.

It should be understood that the magnets 32.2, 32.4 arranged to each side of a given magnet 32.1 have their magnetization vectors oriented in opposing directions. The magnets 32.1 are aligned with the magnets 31.1, the magnets 32.2 are aligned with the magnets 31.2, the magnets 32.3 are aligned with the magnets 31.3, and the magnets 32.4 are aligned with the magnets 31.4.

The third magnetic ring 33 has magnets in the form of annular sectors positioned adjacent to one another by their parallel edges in the sleeve 21 with the same alternation as those of the first magnetic ring 31 to form a Halbach array around the circumference of the sleeve 21. Therefore, there are first magnets 33.1, 33.3 that each have a first magnetization vector extending along a local radius (direction locally normal to the external surface of the outer sleeve 21 facing the magnet 33.1, 33.3 in question) and that are separated in pairs by a second magnet 33.2, 33.4 having a second magnetization vector substantially tangential to the external surface of the sleeve 21 and contained in a plane perpendicular to the central axis of the sleeve 21.

The magnets 33.1, 33.2, 33.3, 33.4 are arranged in a Halbach array, alternating in the circumferential direction of the sleeve 21 as follows: a magnet 33.1, a magnet 33.4, a magnet 33.3, a magnet 33.2, a magnet 33.1, a magnet 33.4, a magnet 33.3, a magnet 33.2 and so on. In this case:
each magnet 33.1 has its magnetization vector emanating from the main surface 33′ (its north pole emerges on the main surface 33′);
each magnet 33.2 has its magnetization vector extending from the adjacent magnet 33.1 towards the adjacent magnet 33.3;
each magnet 33.3 has its magnetization vector entering the main surface 33′ (its south pole emerges on the main surface 33′); and
each magnet 33.4 has its magnetization vector extending from the adjacent magnet 33.1 to the adjacent magnet 33.3.

It should be understood that the magnets 33.2, 33.4 arranged to each side of a given magnet 33.1 have their magnetization vectors oriented in opposing directions. The magnets 33.1 are positioned facing magnets 32.3, the magnets 33.2 are positioned facing magnets 32.2, the magnets 33.3 are positioned facing magnets 32.1, and the magnets 33.4 are positioned facing magnets 32.4.

The magnets are in this case made from rare earths; the ring 22 and the outer sleeve 21 are preferably made from magnetic steel, but may be made from a non-magnetic material.

During operation, the linear electromechanical actuator is arranged, as indicated above, to move the stator 20 axially between:
a first axial position or braking position (shown in FIGS. 2 and 3); and
a second axial position or freely rotating position (shown in FIGS. 6 and 7).

In the first axial position, the outer sleeve 21 is engaged between the sleeve 11.1 and the sleeve 11.2 (the entire length of the magnets 32.1, 32.2, 32.3, 32.4 faces the internal surface 16.1 of the sleeve 11.1 and they are separated from it by a radial air gap; and the entire length of the magnets 33.1, 33.2, 33.3, 33.4 faces the external surface 15.2 of the sleeve 11.2 and they are separated from it by a radial air gap) and the flange 22 is brought closer to the flange 12 (the magnets 31.1, 31.2, 31.3, 31.4 are separated from the main surface of the flange 12 opposite the rim 105 by a first axial air gap). The first magnetic ring 31 is capable of generating eddy currents in the flange 12 of the rotor 10 when the stator 20 is in the first axial position in relation to the rotor 10 and the rotor 10 pivots in relation to the stator 20. The second magnetic ring 32 is capable of generating eddy currents in the sleeve 11.1 of the rotor 10 when the stator 20 is in its first axial position in relation to the rotor 10 and the rotor 10 pivots in relation to the stator 20. The third magnetic ring 33 is capable of generating eddy currents in the sleeve 11.2 of the rotor 10 when the stator 20 is in its first axial position in relation to the rotor 10 and the rotor 10 pivots in relation to the stator 20. The eddy currents generated are likely to produce a significant braking force on the rotor 10.

In the second axial position, the sleeve 21 is disengaged from the sleeves 11.1 and 11.2 (the magnets 32.1, 32.2, 32.3, 32.4 no longer face the internal surface 16.1 of the sleeve 11.1 and the magnets 33.1, 33.2, 33.3, 33.4 no longer face the external surface 15.2 of the sleeve 11.2) and the flange 22 is moved away from the flange 12 (the magnets 31.1, 31.2, 31.3, 31.4 are separated from the main surface of the flange 12 opposite the rim 105 by a second axial air gap greater than the first axial air gap). In this second position, the magnetic rings 31, 32, 33 are no longer capable of generating eddy currents in the rotor 10 that are likely to produce a significant braking force on the wheel when the rotor 10 pivots in relation to the stator 20, irrespective of its speed of rotation.

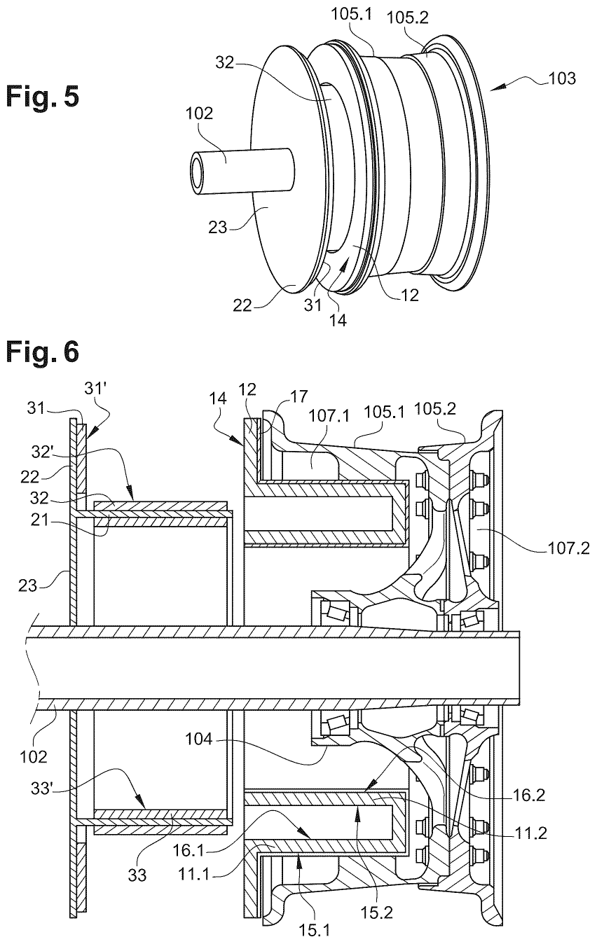

It should be understood that, in order to induce braking, the linear electromechanical actuator is controlled to bring the stator 20 into the first axial position and that, in order to stop braking, the linear electromechanical actuator is controlled to bring the stator 20 into the second axial position, in which position the magnets do not allow sufficient eddy currents to be generated in the rotor 10 to induce braking of the rotor 10. Between the two above positions (the linear electromagnetic actuator may in this case bring the stator into any intermediate position), the magnetic braking device may produce intermediate braking torque values (see FIGS. 4 and 5). It should be noted that, below a certain speed of rotation of the rotor 10, the braking torque is negligible, irrespective of the position of the stator 20.

Elements that are identical or similar to those described above have been given the same reference numbers in figures and hereinafter in the description relating to the variant of the first embodiment and the other embodiments.

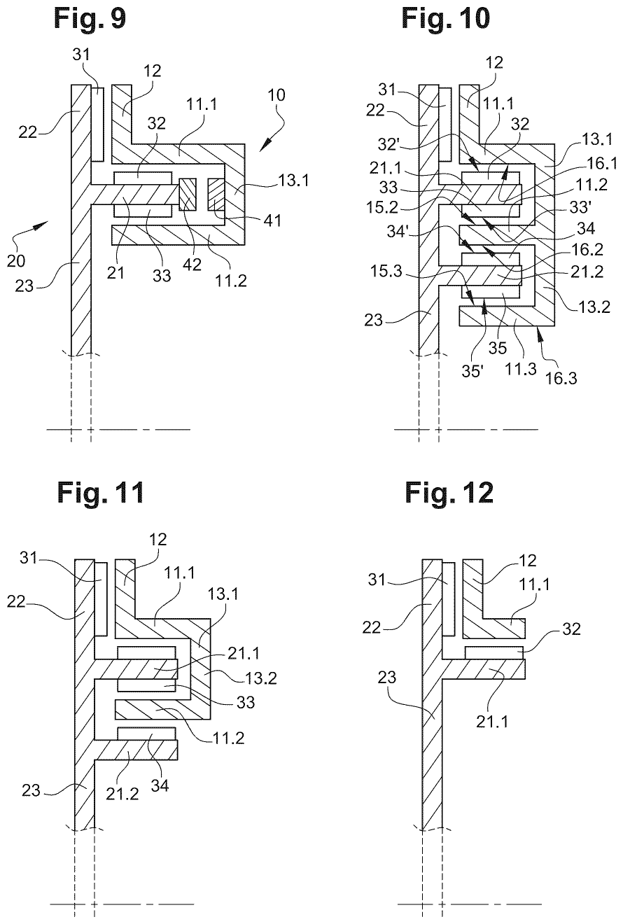

In the variant of FIG. 9, the bottom partition 13.1 and the first end (or free edge) of the outer sleeve 21 are arranged to form friction surfaces and the stator 20 is able to move in relation to the rotor 10 between a friction position in which the friction surfaces are in contact and a frictionless position in which the friction surfaces are spaced apart from one another. The bottom partition 13.1 and the first end of the outer sleeve 21 are in this case provided with friction lining 41, 42. It should be understood that, in the friction position, the magnetic braking device provides both friction braking and eddy current braking whereas, in the frictionless position, the magnetic braking device provides only eddy current braking. The movement of the stator 20 between its two positions is provided by the linear electromechanical actuator.

In the second embodiment of FIG. 10, the rotor 10 comprises a third sleeve 11.3 extending inside the second sleeve 11.2 to form a channel having a bottom partition 13.2 extending radially to join the first end of the second sleeve 11.2 with a first end of the third sleeve 11.3. The third sleeve 11.3 has an external surface 15.3 extending facing the internal surface 16.2 of the second sleeve 11.2 and, on the opposite side, an internal surface 16.3.

The stator 20 comprises an outer sleeve 21.1 identical to the sleeve 21 and an inner sleeve 21.2 that is arranged to be able to be engaged between the sleeves 11.2, 11.3 and that has a first end at the same end as the bottom partition 13.2 and, at the opposite end, a second end secured to the disc component 23.

The braking device comprises a fourth magnetic ring 34 extending around the inner sleeve 21.2 (like the second magnetic ring 32 around the outer sleeve 21.1) and a fifth magnetic ring 35 extending inside the inner sleeve 21.2 (like the second magnetic ring 33 inside the outer sleeve 21.1).

The magnetic ring 34 is fastened to the external cylindrical surface of the inner sleeve 21.2 extending facing the internal surface 16.2 of the second sleeve 11.2. The free main surface 34′ of the magnetic ring 34 forms a fourth surface of the stator 20 through which a radial magnetic flux is emitted towards a fourth surface of the rotor 10 formed by the internal surface 16.2 of the second sleeve 11.2. The free main surface 34′ and the internal surface 16.2 form a fourth pair of magnetic flux passage surfaces when the stator 20 is in the braking position.

The magnetic ring 35 is fastened to the internal cylindrical surface of the inner sleeve 21.2 extending facing the external surface 15.3 of the third sleeve 11.3. The free main surface 35′ of the magnetic ring 35 forms a fifth surface of the stator 20 through which a radial magnetic flux is emitted towards a fifth surface of the rotor 10 formed by the external surface 15.3 of the third sleeve 11.3. The free main surface 35′ and the internal surface 15.3 form a fifth pair of magnetic flux passage surfaces when the stator 20 is in the braking position.

The arrangement of the magnets of the fourth and fifth rings is identical to that of the second and third rings respectively.

Operation is identical to that of the first embodiment. It should be understood that the braking torque is greater with the second embodiment.

The thickness of the second sleeve 11.2 is preferably such that a skin effect (also referred to as Kelvin effect) is generated from each magnetic ring 33, 34 over more than half the thickness of the second sleeve 11.2 at least over a range of possible relative speeds of the rotor 10 in relation to the stator 20. The eddy currents generated from the two magnetic rings 33, 34 will then circulate in the central portion of the second sleeve 11.2, which in-creases the braking torque. This produces a “superimposed skin effect”, the thickness of the second sleeve 11.2 being sufficiently small to achieve this effect while satisfying the thermal and mechanical constraints. In one example, this effect improves performance by approximately 60%.

In reference to FIG. 11 and according to the third embodiment, the rotor 10 comprises a first sleeve 11.1 and a second sleeve 11.2; and the stator comprises an outer sleeve 21.1 and an inner sleeve 21.2 as in the second embodiment.

The magnetic braking device comprises only three magnetic rings 31, 33, 34.

The magnetic ring 31 is fastened to the flat annular surface of the ring 22 extending facing the flat annular surface 14 of the ring 12 opposite the flank of the annular portion 105.1.

The magnetic ring 33 is fastened to the internal cylindrical surface of the outer sleeve 21.1 facing the external surface 15.2 of the second sleeve 11.2.

The magnetic ring 34 is fastened to the external cylindrical surface of the inner sleeve 21.2 extending facing the internal surface 16.2 of the second sleeve 11.2.

Operation is identical to that of the first embodiment.

In reference to FIG. 12 and according to the fourth embodiment, the rotor 10 comprises only a first sleeve 11.1 and the stator comprises only an outer sleeve 21.1.

The magnetic braking device comprises only two magnetic rings 31, 32 that are fixed and arranged as in the first embodiment.

Operation is identical to that of the first embodiment. It should be understood that this embodiment is the simplest and the most lightweight, the trade-off being that it provides the weakest braking torque.

Naturally, the invention is not limited to the described embodiments, but covers any variant that falls within the scope of the invention as defined by the claims.

In particular, the structure of the device may be different to that described.

Preferably, the pluralities of magnets 31, 32, 33, 34, 35 are secured to the stator 20 and the rotor 10 is made from an electrically conductive material. However, as a variant, the magnets may be carried by the rotor instead of the stator.

The shape, arrangement and dimensions of the magnets may be different to those described. Preferably, the first magnets 11, 13 represent approximately 70% of the surface area of the element that carries them, but this is not mandatory. The magnets may or may not have identical lengths and/or widths, and may or may not be positioned symmetrically on a circle passing through the geometric centre of the north poles of the magnets 11 and the south poles of the magnets 13.

Using a Halbach array is not mandatory.

The number of rotors and/or the number of stators may be different to those mentioned, as may the number of sleeves and flanges for each of them.

The magnetic braking device may use permanent magnets and electromagnets powered via cables to inhibit or rein-force the magnetic field of the permanent magnets, the stator then being stationary in translation.

Preferably, the rotor 10 comprises a layer of copper and a layer of magnetic steel.

The actuators may generally be hydraulic or electric.

The rolling device may comprise an additional friction braking device which comprises rotors and stators to form a stack of discs, coaxial to the wheel 103, and therefore having central axes that coincide with the axis of rotation of the wheel 103. The stators and the rotors are arranged in alternation and have main faces that face each other and are parallel to each other so as to be able to be pressed against each other and provide friction braking. The pressing force of the stack of discs is applied by actuators that can be controlled by the pilot of the aeroplane, in a manner that is known per se, in order to move the stators so as to be able to press or release the stack of discs and apply, modulate or interrupt the braking force on the wheel 103. The friction braking device is known per se and shall not be described in further detail here. The actuators of the friction brake may be hydraulic or electromechanical. Each electromechanical actuator comprises an electric motor and a pusher that can be moved by the electric motor to press the stack of discs. The electromechanical actuator is thus intended to produce a controlled braking force on the stack of discs. One method for controlling braking devices is known from document FR-A-2953196, for example.

The invention can be used on any type of vehicle.

1. A rolling device for a vehicle, comprising a wheel having a hub arranged to be mounted to pivot on a shaft and a rim linked to the hub by a disc so as to extend coaxially with the hub, the rim comprising at least one first annular portion protruding axially from the disc and delimiting therewith a recess receiving an eddy current magnetic braking device comprising a stator constrained to rotate with the shaft, a rotor constrained to rotate with the wheel and provided with a first surface facing a first surface of the stator to form a first pair of surfaces, and at least a first plurality of magnets for generating a first magnetic flux which passes through the first pair of surfaces, characterized in that the rotor comprises at least one second surface facing a second surface of the stator to form a second pair of surfaces and the magnetic braking device comprises at least a second plurality of magnets for generating a second magnetic flux which passes through the second pair of surfaces, and in that the first pair of surfaces and the first plurality of magnets are arranged in such a way that the first magnetic flux is axial and the second pair of surfaces and the second plurality of magnets are arranged in such a way that the second magnetic flux is radial.

2. The rolling device according to claim 1, in which the first pair of surfaces is arranged in the vicinity of a rim flank secured to the first annular portion of the rim opposite the disc and the second pair of surfaces is arranged in the recess in the vicinity of the first annular portion of the rim.

3. The rolling device according to claim 1, in which the rotor has at least one third surface facing a third surface of the stator to form a third pair of surfaces and the magnetic braking device comprises at least a third plurality of magnets for generating a third magnetic flux, which is radial, passing through the third pair of surfaces.

4. The rolling device according to claim 3, in which the rotor has at least one fourth surface facing a fourth surface of the stator to form a fourth pair of surfaces and the magnetic braking device comprises at least a fourth plurality of magnets for generating a fourth magnetic flux, which is radial, passing through the fourth pair of surfaces.

5. The rolling device according to claim 1, in which: the rotor comprises a first rotor sleeve that extends in the recess along the annular portion of the rim and a rotor flange protruding outwards from the first rotor sleeve in such a way as to extend in front of a flank secured to the annular portion of the rim; the rotor flange having, opposite the flank of the rim, a surface forming the first surface of the rotor and the first sleeve having a surface forming the second surface of the rotor; and the stator comprising an stator outer sleeve and a stator flange protruding outwards from the stator outer sleeve in such a way as to have a surface forming the first surface of the stator extending facing the first surface of the rotor to form the first pair of surfaces, the stator outer sleeve being arranged to be engaged in the first rotor sleeve and have a surface forming the second surface of the stator facing the second surface of the first rotor sleeve to form the second pair of surfaces.

6. The rolling device according to claim 5, in which the second surface of the stator is a free surface of the second plurality of magnets carried by an external surface of the stator outer sleeve facing an internal surface of the first rotor sleeve forming the second surface of the rotor.

7. The rolling device according to claim 5, in which the rotor comprises a second rotor sleeve delimiting, with the first rotor sleeve, a channel in which the stator outer sleeve is engaged.

8. The rolling device according to claim 7, in which the magnetic braking device comprises at least a third plurality of magnets mounted in the stator outer sleeve to generate a third magnetic flux, which is radial, passing through a third pair of surfaces, the second rotor sleeve having an external surface forming a third surface of the rotor facing a free surface of the third plurality of magnets forming a third surface of the stator to form the third pair of surfaces.

9. The rolling device according to claim 7, in which the magnetic braking device comprises at least a third plurality of magnets mounted on a stator inner sleeve to generate a third magnetic flux, which is radial, passing through a third pair of surfaces, and the second rotor sleeve has:
an external surface forming the second surface of the rotor facing a free surface of the second plurality of magnets mounted in the stator outer sleeve forming the second surface of the stator; and
an internal surface extending facing a free surface of the third plurality of magnets forming the third surface of the stator.

10. The rolling device according to claim 6, in which the magnetic braking device comprises at least a third plurality of magnets secured to the internal surface of the stator outer sleeve to generate a third magnetic flux, which is radial, passing through a third pair of surfaces, and a fourth plurality of magnets secured to the external surface of a stator inner sleeve to generate a fourth magnetic flux, which is radial, passing through a fourth pair of surfaces; in which the second rotor sleeve has an external surface forming the third surface of the rotor facing a free surface of the third plurality of magnets forming the third surface of the stator, and an internal surface forming the fourth surface of the rotor extending facing a free surface of the fourth plurality of magnets forming the fourth surface of the stator.

11. The rolling device according to claim 10, in which the rotor comprises a third rotor sleeve having an external surface forming the fifth surface of the rotor facing a free surface of a fifth plurality of magnets secured to an internal surface of the stator inner sleeve forming the fifth surface of the stator.

12. The rolling device according to claim 8, in which a bottom partition joins the first rotor sleeve and the second rotor sleeve opposite a free edge of the stator outer sleeve, the bottom partition and the free edge of the stator outer sleeve being arranged to form friction surfaces and the stator being able to move in relation to the rotor between a friction position in which the friction surfaces are in contact and a frictionless position in which the friction surfaces are spaced apart from one another.

13. The rolling device according to claim 1, in which the control member comprises a linear actuator linked to the stator to move the stator axially between a braking position in which the facing surfaces are brought closer together and a freely rotating position in which the facing surfaces are moved apart.

14. The rolling device according to claim 1 forming part of an aircraft landing gear.

15. An aircraft comprising a structure to which at least one of the rolling device according to claim 1 is fastened.
